(19) United States
(12) Patent Application Publication
(10) Pub. No.: US 2025/0220746 A1
(43) Pub. Date: Jul. 3, 2025

(54) MULTI-LINK DEVICE BASED RELAY

(71) Applicant: Cisco Technology, Inc., San Jose, CA (US)

(72) Inventors: Brian D. Hart, Sunnyvale, CA (US); Malcolm M. Smith, Richardson, TX (US)

(73) Assignee: Cisco Technology, Inc., San Jose, CA (US)

(21) Appl. No.: 18/786,178

(22) Filed: Jul. 26, 2024

Related U.S. Application Data
(60) Provisional application No. 63/616,546, filed on Dec. 30, 2023.

(51) Int. Cl. H04W 76/15; H04W 84/12

(52) U.S. Cl. CPC H04W 76/15; H04W 84/12

(57) ABSTRACT

Multi-Link Device (MLD) based relay support may be provided. Support a MLD relay can include provisioning a Virtual Media Access Control (vMAC) address for the MLD relay between a Transmitter STA (tSTA) and a Destination STA (dSTA). The MLD relay is configured, comprising determining a bridging configuration between a first link with the tSTA and a second link with the dSTA. A transmission from the tSTA is received via the first link, and the transmission is relayed to the dSTA via the second link.

### RELATED APPLICATION

Under provisions of 35 U.S.C. § 119(e), Applicant claims the benefit of and priority to U.S. Provisional Application No. 63/616,546, filed Dec. 30, 2023, the disclosure of which is incorporated herein by reference in its entirety.

### TECHNICAL FIELD

The present disclosure relates generally to providing Multi-Link Device (MLD) based relay support.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Multi-Link Device (MLD) based relay support in accordance with aspects of the present disclosure.

FIG. 2 is a block diagram of a signal process for MLD based relay in accordance with aspects of the present disclosure.

FIG. 3 is a block diagram of a second signal process for MLD based relay in accordance with aspects of the present disclosure.

FIG. 4 is a flow chart of a method for MLD relay support accordance with aspects of the present disclosure.

FIG. 5 is a block diagram of a computing device in accordance with aspects of the present disclosure.

FIG. 6 is a block diagram of a wireless device in accordance with aspects of the present disclosure.

### DETAILED DESCRIPTION

### Overview

Multi-Link Device (MLD) based relay support may be provided. Support a MLD relay can include provisioning a Virtual Media Access Control (vMAC) address for the MLD relay between a Transmitter STA (tSTA) and a Destination STA (dSTA). The MLD relay is configured, comprising determining a bridging configuration between a first link with the tSTA and a second link with the dSTA. A transmission from the tSTA is received via the first link, and the transmission is relayed to the dSTA via the second link.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In networking, a Station (STA), such as an Access Point (AP), may have weak zones or dead zones in its coverage area. The STA may use a relay to enable a sufficient connection in weak zones, dead zones, and/or areas beyond the STA's typical coverage area. To relay the transmission, the Transmitter STA (tSTA) may transmit to a Relay STA (rSTA), and the rSTA may relay the transmission to a Destination STA (dSTA). The rSTA may be positioned to provide a coverage area that extends beyond the coverage area of the tSTA, such as where the dSTA is positioned, or the rSTA may otherwise have improved connections to the tSTA and the dSTA. For example, the Modulation and Coding Scheme (MCS) of the connection between the tSTA and the dSTA may be lower than the MCS between the rSTA and both the tSTA and the dSTA.

Multi-Link Devices (MLDs) can connect to other devices using multiple bands to send and receive data across different frequency bands and channels. Thus, a client STA and an AP can establish multiple links between the two devices. The Multi-Link Operation (MLO) of MLDs can improve throughput, reduce latency, and improve reliability. However, there is no existing relay mode for maintaining the utility of MLDs while communicating utilizing the relay when (i) one of the MLD entities (tSTA or dSTA) is an AP, (ii) both MLD entities are APs on the same Wireless Local Area Network (WLAN) or Virtual Local Area Network (VLAN), or (iii) both MLD entities are APs on a different WLAN or VLAN.

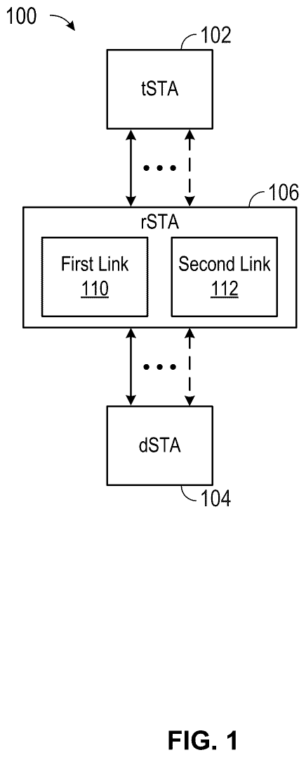

FIG. 1 is a block diagram of an operating environment 100 for MLD based relay support. The operating environment 100 includes a tSTA 102, a dSTA 104, and a rSTA 106. The tSTA 102 and the dSTA 104 can be any device that connects to the network to communicate with other devices on the network, such as a smart phone, a tablet, a personal computer, a server, an AP, and/or the like.

The rSTA 106 may be an MLD operable to relay transmissions between devices, such as the tSTA 102 and the dSTA 104. The rSTA 106 may be an AP MLD in certain embodiments. The rSTA 106 includes a first link 110 and a second link 112 but may include additional links in other examples. The first link 110 and the second link 112 can be physical or virtual devices (e.g., STA, AP) that enable devices to communicate. For example, the tSTA 102 can use the first link 110 and/or the second link 112 to communicate with the dSTA 104 via relay. The first link 110 and the second link 112 can operate together to perform different functions for the relay, such as the first link 110 receiving from the tSTA 102 and the second link 112 transmitting the data received by the first link 110 to the dSTA 104. The tSTA 102 may be the device transmitting to the dSTA 104 in the illustrated example for clarity, but the tSTA 102 and the dSTA 104 may both use to the rSTA 106 to send transmissions via relay and receive transmissions via relay.

The rSTA 106 may have one or more links to both the tSTA 102 and the dSTA 104. Thus, the rSTA 106 can relay transmissions between the tSTA 102 and the dSTA 104 using multiple links. The tSTA 102 and the dSTA 104 may be able to communicate directly in some embodiments, but the relay via the rSTA 106 may provide a more reliable connection. To enable the relay while providing MLD support to the tSTA 102 and the dSTA 104, the rSTA 106 manages the separation of the logical MLD function on any non-AP STA that is peered with the AP MLD (the rSTA 106) between two physically separate entities (the tSTA 102 and the dSTA 104). Additionally, maintaining the utility of MLD within a relay can require not breaking any fundamental assumptions of MLD. One assumption MLDs use for operation is that the individual links of the same non-AP MLD entity are co-located or associated with the same device and have the same endpoint. For example, the endpoint may be a Layer 2 (L2) or Ethernet endpoint and its port address may be the virtual Media Access Control (vMAC) (e.g., MLD MAC address or L2 Ethernet MAC address at the MAC Service Access Point (SAP)).

The assumptions MLDs use, especially for vMAC endpoint assumptions, may be emulated in the relay to effectively utilize the MLD capabilities. For example, a frame addressed to the rSTA 106 itself (e.g., via its vMAC) that enters the network from either side of the relay should be delivered to the rSTA 106. Likewise, a frame addressed to a relayed end point (e.g., the dSTA 104) should be bridged through or otherwise relayed to the end point using its link vMAC. Similarly, a frame addressed to the tSTA 102 should relayed to the tSTA 102 end point when the roles of the tSTA 102 and the dSTA 104 are switched. There are three cases for the rSTA 106 and/or other devices implementing a relay to handle: (i) when one of the MLD entities utilizing the relay (i.e., the tSTA 102 or the dSTA 104) is an AP, (ii) when both of the MLD entities are APs on the same network (i.e., same WLAN or VLAN), and (iii) when both of the MLD entities are APs on different networks (i.e., different WLAN or VLAN).

To emulate the MLD assumptions and enable MLD with the relay, the vMAC address of the rSTA 106 may be provisioned in both ends of the relay between the tSTA 102 and the dSTA 104 via a vMAC assignment exchange. For example, the tSTA 102, acting as a MLD STA, can send the vMAC address and/or other information for provisioning the vMAC address for the relay to the rSTA 106. The rSTA 106, acting as an MLD AP, can relay the vMAC address and/or other information for provisioning the vMAC address for the relay to the dSTA 104 or other relay end point. Thus, the vMAC will be provisioned and topologically correct for the relay connection. The rSTA 106 can broadcast the provisioned vMAC via MLD signaling, such as capabilities and operation signaling. Using the provisioned vMAC, the tSTA 102 can communicate with the dSTA 104 via multiple links using the rSTA 106. For example, the rSTA 106 can simultaneously receive from the tSTA 102 using the first link 110 and transmit to the dSTA 104 using the second link 112. The vMAC provisioning can also include enabling the dSTA 104 to transmit to the tSTA 102 in some embodiments, such as enabling the dSTA 104 to transmit to the second link 112 and the rSTA 106 relaying the transmission to the tSTA 102 via the first link 110. vMAC provisioning can comprise any combination of operations for assigning a vMAC to devices.

The rSTA 106 and/or the other devices of the relay may utilize a bridging function to enable the rSTA 106 to relay frames via multiple links, such as receiving from the tSTA 102 via the first link 110 and transmitting to the dSTA 104 using the second link 112. The rSTA 106 can utilize the bridging function to transfer data between links as needed to relay information. Thus, an example bridging configuration between the tSTA 102 and the dSTA 104 is to bridge transmissions received on the first link 110 from the tSTA 102 to the second link 112 so the rSTA 106 can relay the transmissions to the dSTA 104 via the second link 112. The bridging configuration can include setting the dSTA 104 as an L2 endpoint. When the dSTA 104 is configured as a L2 endpoint, a L2 loop can be prevented from forming. The bridging configuration can also include enabling the dSTA 104 to transmit to the tSTA 102 in certain embodiments, such as enabling the dSTA 104 to transmit to the second link 112 and the rSTA 106 relaying the transmission to the tSTA 102 via the first link 110.

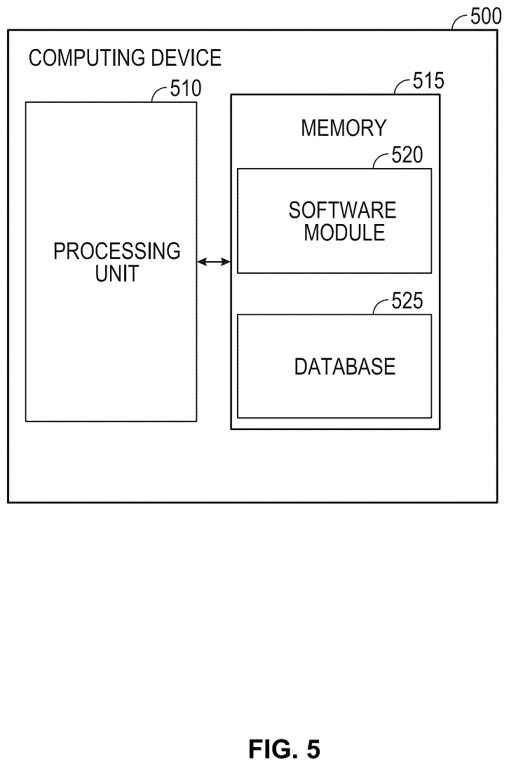

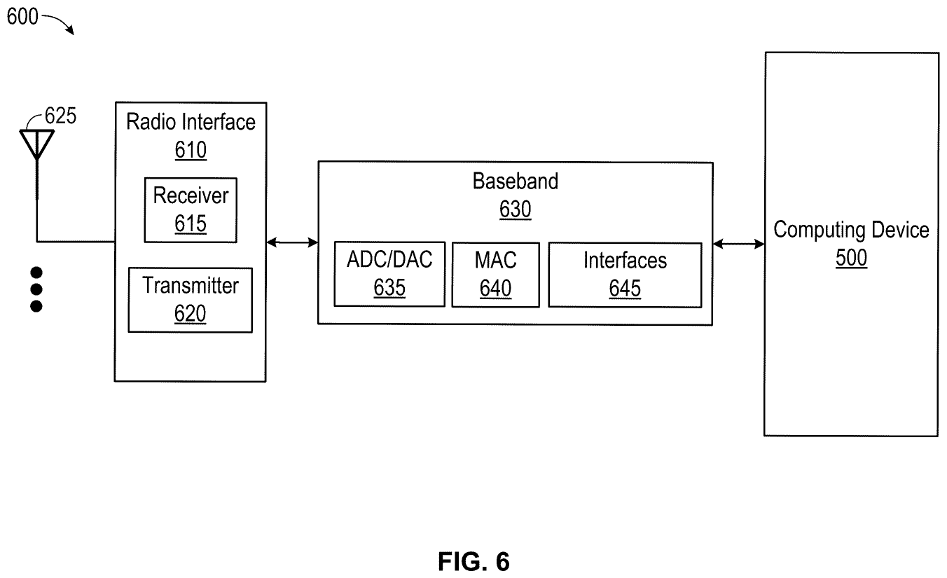

The elements described above of the operating environment 100 (e.g., the tSTA 102, the dSTA 104, the rSTA 106, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

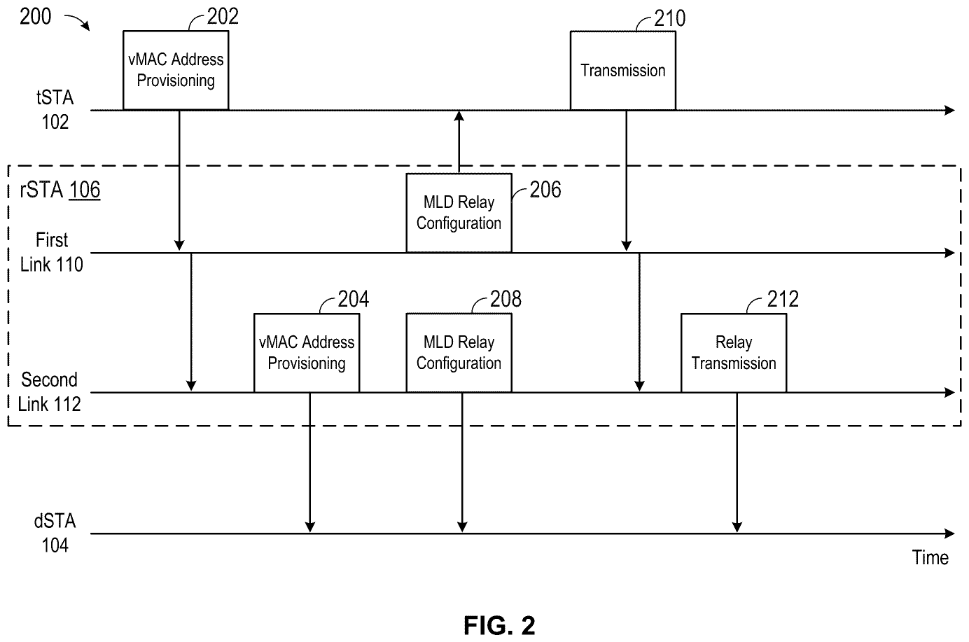

FIG. 2 is a block diagram of a signal process 200 for MLD based relay. The signal process 200 can be between the tSTA 102, the dSTA 104, and the rSTA 106. In the illustrated example, the tSTA 102 communicates with the rSTA 106 via the first link 110, and the dSTA 104 communicates with the rSTA 106 via the second link 112. The tSTA 102, dSTA 104, and/or the rSTA 106 may communicate via a different combination of links in other embodiments.

The signal process 200 may begin with vMAC address provisioning, such as the provisioning described above. The tSTA 102 sends a vMAC address provisioning frame 202 to the rSTA 106 via the first link 110. The vMAC address provisioning frame 202 can include the vMAC address(es) to use for the relay between the tSTA 102 and the dSTA 104 and/or other information for provisioning the vMAC address(es) for the relay. The rSTA 106 can send a relay vMAC address provisioning frame 204 to the dSTA 104 via the second link 112. The relay vMAC address provisioning frame 204 can include the vMAC address(es) to use for the relay between the tSTA 102 and the dSTA 104 and/or other information for provisioning the vMAC address(es) for the relay. The relay vMAC address provisioning frame 204 may just be a relay of the vMAC address provisioning frame 202 or the rSTA 106 may modify the relay vMAC address provisioning frame 204 to only include information the dSTA 104 needs for vMAC provisioning. The rSTA 106 may send the relay vMAC address provisioning frame 204 at the same time the rSTA 106 receives the vMAC address provisioning frame 202 in certain embodiments. In further embodiments, the rSTA 106 may provision the vMAC address and send the a vMAC address provisioning frame to the tSTA 102 and/or the dSTA 104.

The rSTA 106 may determine a bridging configuration to enable the relay between the tSTA 102 and the dSTA 104 via multiple links, such as via the operations described above. The bridging configuration can include determining how to bridge links for the relay (e.g., bridge transmissions received on the first link 110 to the second link 112), setting the dSTA 104 as an L2 endpoint, and/or the like.

Other operations of MLDs, such as power-savings, Target Wait Time (TWT), restricted TWT (rTWT), etc., are generally handled by link specific methods and may not affect relay operation directly or be affected by relay operation. Thus, these operations can be implemented during the operation of the relay. For example, the links can be awake at the same time and can all receive during a period, all transmit during a period, and/or the like. However, some operations may need to be disabled or otherwise controlled to enable the MLD relay. For example, the rSTA 106 may disable or otherwise prohibit Enhanced Multi-Link Single-Radio (eMLSR) operation to ensure the relay between the tSTA 102 and the dSTA 104 operates correctly.

Non-Simultaneous Transmit and Receive (NSTR) may also be supported by the rSTA 106 only and disabled or otherwise prohibited for the tSTA 102 and the dSTA 104. NSTR may be limited to the rSTA 106 to avoid coordination of the end-points controlled by the rSTA 106 that can lead to interference, collisions, and/or other issues for the relay when transmissions such as responses, Acknowledges, and the like are not sent at times that cause transmissions to overlap. However, the rSTA 106 may use Simultaneous Transmit and Receive (STR) whenever possible to increase the speed at which the relay can operate transmitting and receiving simultaneously over multiple links.

Once the rSTA 106 has determined the MLD relay configuration (whether during the signal process 200 or before), the rSTA 106 may send the MLD relay configuration to the tSTA 102 via the signal 206 and to the dSTA 104 via the signal 208. The signal 206 and the signal 208 can indicate how the tSTA 102 and dSTA 104 should operate respectively, such as setting the dSTA 104 as an L2 endpoint, identifying the links to use for the relay, disabling eMLSR, disabling NSTR, and/or the like. The signal 206 and the signal 208 may comprise Information Elements, action frames, and/or the like.

Once the MLD relay is configured, the tSTA 102 can send a transmission 210 meant for the dSTA 104. The rSTA 106 can receive the transmission via the first link 110 and bridge the transmission 210 to the second link 112. The rSTA 106 can forward the transmission 210 as a relay transmission 212 to the dSTA 104 via the second link 112. In certain embodiments, the rSTA 106 sends the relay transmission 212 simultaneously with the reception of the transmission 210. Thus, the rSTA 106 implements MLD operations for the relay between the tSTA 102 and the dSTA 104. The signal process 200 can continue indefinitely with the tSTA 102 relaying transmissions to the dSTA 104 via the MLD relay supported by the rSTA 106. In some embodiments, the rSTA 106 may also enable the MLD relay for the dSTA 104 to send transmissions to the tSTA 102.

The signal process 200 can include additional signaling not shown. For example, the signal process 200 can include Acknowledge signals the devices exchange to acknowledge the reception of transmissions (e.g., the rSTA 106 sending an Acknowledge to the tSTA 102 in response to receiving the transmission 210, the dSTA 104 sending an Acknowledge to the rSTA 106 in response to receiving the relay transmission 212, etc.). The MLD relay can be used to forward additional signals, for instance to notify the tSTA 102 received the transmission 210 via the rSTA 106.

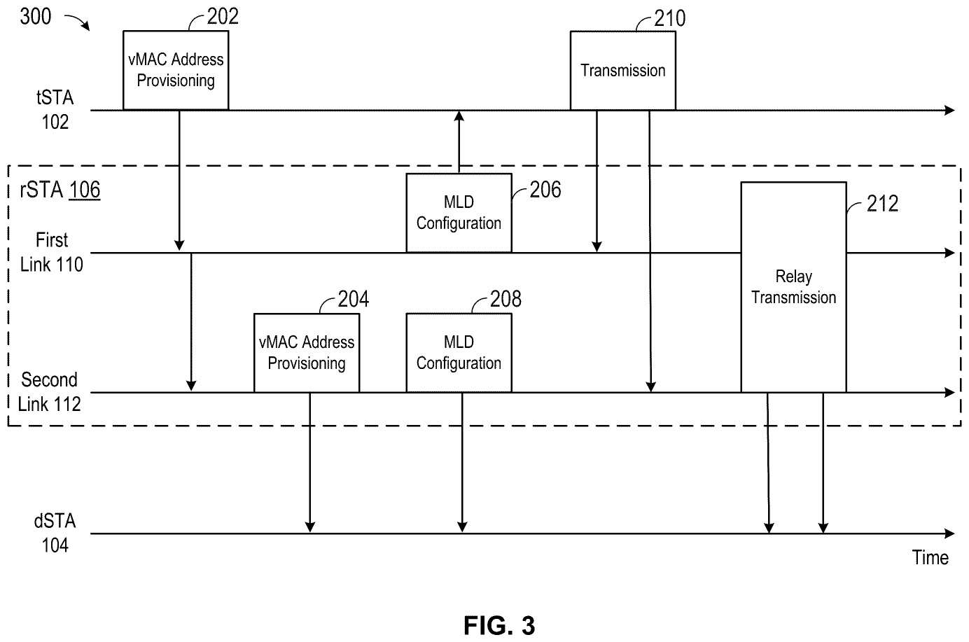

FIG. 3 is a block diagram of a second signal process 300 for MLD based relay. The second signal process 300 can be an optional enhancement of the signal process 200. Thus, the second signal process 300 can include the vMAC provisioning with the vMAC address provisioning frame 202 and the relay vMAC address provisioning frame 204 and MLD relay configuration with the signal 206 and signal 208.

In the second signal process 300, the MLD relay may include splitting the MAC Service Data Unit (MSDU) Traffic Identifiers (TIDs) (e.g., per traffic class) of the transmission 210 between the first link 110 and the second link 112. Thus, the rSTA 106 can receive the transmission 210 via the first link 110 and the second link 112, for example based on the traffic class of the data. Splitting the transmission 210 between first link 110 and the second link 112 can prevent the need to pass MAC Protocol Data Unit (MPDU) and/or Acknowledge states between the tSTA 102 and the dSTA 104. The rSTA 106 can perform a MSDU transfer from the source link (e.g., the first link 110 linked to the tSTA 102) to new MPDUs in the destination link (e.g., the second link 112 linked to the dSTA 104) via another per-TID structure. In some embodiments, the rSTA 106 can use TID-to-Link Mapping (T2LM) for splitting the transmission 210 over multiple links. The relay transmission 212 can thus be sent to the dSTA 104 via the first link 110 and the second link 112.

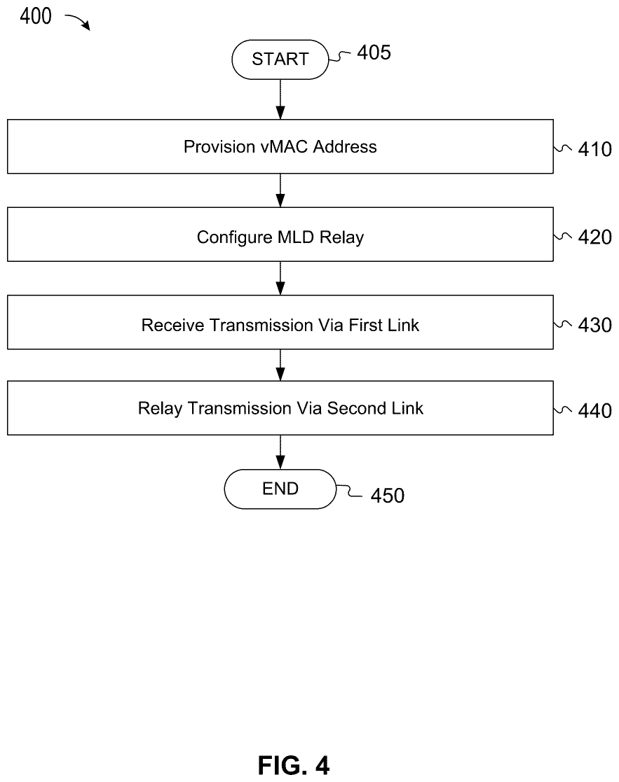

FIG. 4 is a flow chart of a method 400 for MLD relay support. The method 400 can begin at starting block 405 and proceed to operation 410. In operation 410, a vMAC address is provisioned for a MLD relay. For example, the tSTA 102, the dSTA 104, and/or the rSTA 106 provision the vMAC address for the MLD relay between the tSTA 102 and the dSTA 104. In some embodiments, the tSTA 102 and/or the dSTA 104 are APs. In certain embodiments, the tSTA 102 and the dSTA 104 are both APs on the same Local Area Network (LAN) (i.e., WLAN, VLAN) or different LANs. Provisioning the vMAC address can include the rSTA 106 receiving the vMAC address from the tSTA 102 and relaying the vMAC address to the dSTA 104.

In operation 420, the MLD relay is configured. For example, the rSTA 106 configures the MLD relay as described above. Configuring the MLD relay can include determining a bridging configuration between the first link 110 and the second link 112, indicating how the tSTA 102 and dSTA 104 should operate, setting the dSTA 104 as an L2 endpoint, identifying the links to use for the relay, disabling eMLSR, disabling NSTR, and/or the like.

In operation 430, a transmission is received. For example, the rSTA 106 receives the transmission 210 from the tSTA 102 via the first link 110. In operation 440, the transmission is relayed. For example the rSTA 106 relays the transmission 210 to the dSTA 104. Once the MLD relay is provisioned, the tSTA 102 can utilize the rSTA 106 to relay transmissions to the dSTA 104 according to the MLD relay configuration.

In some embodiments, the method 400 can include splitting MSDU TIDs of the transmission between the first link 110 and the second link 112. Splitting the MSDU TIDs can include using T2LM. The method 400 can conclude at ending block 450.

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for MLD relay support with respect to FIG. 1, FIG. 2, FIG. 3, and FIG. 4. Computing device 500, for example, may provide an operating environment for the tSTA 102, the dSTA 104, the rSTA 106, and the like. The tSTA 102, the dSTA 104, the rSTA 106, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

FIG. 6 illustrates an implementation of a communications device 600 that may implement one or more of the tSTA 102, the dSTA 104, the rSTA 106, controllers, etc., of FIGS. 1-4. In various implementations, the communications device 600 may comprise a logic circuit. The logic circuit may include physical circuits to perform operations described for one or more of the tSTA 102, the dSTA 104, the rSTA 106, controllers, etc., of FIGS. 1-4, for example. As shown in FIG. 6, the communications device 600 may include one or more of, but is not limited to, a radio interface 610, baseband circuitry 630, and/or the computing device 500.

The communications device 600 may implement some or all of the structures and/or operations for the tSTA 102, the dSTA 104, the rSTA 106, controllers, etc., of FIGS. 1-4, storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHYsical layer (PHY) processing circuit for the PHY link layer processing of respective receive/transmit signals. Baseband circuitry 630 may include, for example, a Media Access Control (MAC) processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
provisioning a Virtual Media Access Control (vMAC) address for a Multi-Link Device (MLD) relay between a Transmitter STA (tSTA) and a Destination STA (dSTA);
configuring the MLD relay, comprising determining a bridging configuration between a first link with the tSTA and a second link with the dSTA;
receiving a transmission from the tSTA via the first link; and
relaying the transmission to the dSTA via the second link.

2. The method of claim 1, wherein the tSTA is an Access Point (AP).

3. The method of claim 1, wherein the tSTA and the dSTA are both APs on any one of (i) a same Local Area Network (LAN), or (ii) on different LANs.

4. The method of claim 1, wherein provisioning the vMAC address comprises:
receiving the vMAC address from the tSTA; and
relaying the vMAC address to the dSTA.

5. The method of claim 1, wherein configuring the MLD relay comprises any one of (i) setting the dSTA as a Layer 2 endpoint, (ii) disabling Enhanced Multi-Link Single-Radio (eMLSR) operation, (iii) disabling Non-Simultaneous Transmit and Receive (NSTR), or (iv) any combination of (i)-(iii).

6. The method of claim 1, further comprising:
splitting MAC Service Data Unit (MSDU) Traffic Identifiers (TIDs) of the transmission between the first link and the second link.

7. The method of claim 1, wherein splitting the MSDU TIDs comprises using TID-to-Link Mapping (T2LM).

8. A system comprising:
a memory storage; and
a processing unit coupled to the memory storage, wherein the processing unit is operative to:
provision a Virtual Media Access Control (vMAC) address for a Multi-Link Device (MLD) relay between a Transmitter STA (tSTA) and a Destination STA (dSTA);
configure the MLD relay, comprising to determine a bridging configuration between a first link with the tSTA and a second link with the dSTA;
receive a transmission from the tSTA via the first link; and
relay the transmission to the dSTA via the second link.

9. The system of claim 8, wherein the tSTA is an Access Point (AP).

10. The system of claim 8, wherein the tSTA and the dSTA are both APs on any one of (i) a same Local Area Network (LAN), or (ii) on different LANs.

11. The system of claim 8, wherein to provision the vMAC address comprises to:
receive the vMAC address from the tSTA; and
relay the vMAC address to the dSTA.

12. The system of claim 8, wherein to configure the MLD relay comprises any one of (i) to set the dSTA as a Layer 2 endpoint, (ii) to disable Enhanced Multi-Link Single-Radio (eMLSR) operation, (iii) to disable Non-Simultaneous Transmit and Receive (NSTR), or (iv) any combination of (i)-(iii).

13. The system of claim 8, the processing unit being further operative to:
split MAC Service Data Unit (MSDU) Traffic Identifiers (TIDs) of the transmission between the first link and the second link.

14. The system of claim 8, wherein to split the MSDU TIDs comprises to use TID-to-Link Mapping (T2LM).

15. A non-transitory computer-readable medium that stores a set of instructions which when executed perform a method executed by the set of instructions comprising:
provisioning a Virtual Media Access Control (vMAC) address for a Multi-Link Device (MLD) relay between a Transmitter STA (tSTA) and a Destination STA (dSTA);
configuring the MLD relay, comprising determining a bridging configuration between a first link with the tSTA and a second link with the dSTA;
receiving a transmission from the tSTA via the first link; and
relaying the transmission to the dSTA via the second link.

16. The non-transitory computer-readable medium of claim 15, wherein the tSTA is an Access Point (AP).

17. The non-transitory computer-readable medium of claim 15, wherein the tSTA and the dSTA are both APs on any one of (i) a same Local Area Network (LAN), or (ii) on different LANs.

18. The non-transitory computer-readable medium of claim 15, wherein provisioning the vMAC address comprises:
receiving the vMAC address from the tSTA; and
relaying the vMAC address to the dSTA.

19. The non-transitory computer-readable medium of claim 15, wherein configuring the MLD relay comprises any one of (i) setting the dSTA as a Layer 2 endpoint, (ii) disabling Enhanced Multi-Link Single-Radio (eMLSR) operation, (iii) disabling Non-Simultaneous Transmit and Receive (NSTR), or (iv) any combination of (i)-(iii).

20. The non-transitory computer-readable medium of claim 15, the method executed by the set of instructions further comprising:
splitting MAC Service Data Unit (MSDU) Traffic Identifiers (TIDs) of the transmission between the first link and the second link.
